(19) United States
(12) Patent Application Publication
(10) Pub. No.: US 2025/0179249 A1
(43) Pub. Date: Jun. 5, 2025

(54) POLYAMIDES MADE FROM CARBON DIOXIDE, OLEFIN, AND AMINE AND CORRESPONDING COMPOSITES

(71) Applicants: James Eagan, Akron, OH (US); Keaton Turney, Salem, OH (US)

(72) Inventors: James Eagan, Akron, OH (US); Keaton Turney, Salem, OH (US)

(21) Appl. No.: 18/841,112

(22) PCT Filed: Feb. 27, 2023
(86) PCT No.: PCT/US2023/013957

§ 371 Date: Aug. 23, 2024

Related U.S. Application Data
(60) Provisional application No. 63/313,937, filed on Feb. 25, 2022.

(51) Int. Cl. C08G 69/00; C08J 5/24; C08J 11/10

(52) U.S. Cl. CPC C08G 69/00; C08J 5/243; C08J 11/10; C08J 2377/00

(57) ABSTRACT

A method of producing a polymer includes steps of providing δ-valerolactone 2-ethylidene-6-hepten-5-olide (EVL); providing an amine-containing compound; allowing the EVL and the amine-containing compound to be mixed to form a mixture; and subjecting the mixture to conditions that will allow the EVL to chemically combine with the amine-containing compound to produce the polymer. A method of producing a monomer includes steps of providing carbon dioxide and an olefin in a first reaction mixture; and subjecting the first reaction mixture to conditions that will allow the carbon dioxide to be chemically bonded with the olefin to form a monomer. A composition includes a combination product of a lactone; and an amine-containing compound.

### CROSS-REFERENCE TO RELATED APPLICATIONS

This application claims the benefit of U.S. Provisional Application No. 63/313,937, filed on Feb. 25, 2022, which is incorporated herein by reference.

### FIELD OF THE INVENTION

One or more embodiments of the present invention relate to polyamides made from carbon dioxide, an olefin, and an amine. One or more embodiments of the present invention relate to reacting 8-valerolactone 2-ethylidene-6-hepten-5-olide (EVL) with an amine. One or more embodiments of the present invention relate to thermosets, thermoplastics, and other materials made from EVL.

### BACKGROUND OF THE INVENTION

Current efforts are being undertaken to capture carbon dioxide (CO₂). Certain efforts include the catalytic incorporation of carbon dioxide (CO₂) with olefins (e.g. 1,3-butadiene), which can yield hydrolytically degradable polyesters. CO₂ and butadiene have been reacted in the presence of a phosphine-ligated palladium catalyst, which produced the unsaturated disubstituted delta (δ)-valerolactone 2-ethylidene-6-hepten-5-olide (EVL). The EVL has been copolymerized with dithiols, ethylene, or methacroyl moieties to produce polysulfide, polyolefin, and polyacrylate repeating units, respectively.

Epoxy composites are high-strength crosslinked thermosetting matrixes, which can be formed through the reaction of low-viscosity bisglycidyl ethers and multifunctional amine precursors. This can include bisphenol-A glycidyl ether being reacted with an amine hardener, where structural variations impart tunable thermomechanical properties. However, epoxy composites are generally not sustainably made, and there remains a need to make such high-performance composites in a more sustainable manner.

There remains a desire to incorporate carbon dioxide into useful materials, such as thermosets, thermoplastics, and high-strength composites, especially for offsetting the economic and energy costs of carbon capture.

### SUMMARY OF THE INVENTION

A first embodiment provides a method of producing a polymer, the method including steps of providing δ-valerolactone 2-ethylidene-6-hepten-5-olide (EVL); providing an amine-containing compound; allowing the EVL and the amine-containing compound to be mixed to form a mixture; and subjecting the mixture to conditions that will allow the EVL to chemically combine with the amine-containing compound to produce the polymer.

A second embodiment provides a method as in any of the above embodiments, wherein the amine-containing compound is a polyfunctional amine compound.

A third embodiment provides a method as in any of the above embodiments, wherein the polyfunctional amine compound is selected from a diamine compound, a triamine compound, and a tetraamine compound.

A fourth embodiment provides a method as in any of the above embodiments, wherein the EVL and the amine-containing compound are at relatively high purities or are at relatively low purities.

A fifth embodiment provides a method as in any of the above embodiments, further comprising a step of mixing the EVL and the amine-containing compound with fibers, or mixing the polymer with fibers.

A sixth embodiment provides a method as in any of the above embodiments, wherein the fibers are selected from glass fibers, carbon fibers, silica fibers, natural fibers, and synthetic fibers.

A seventh embodiment provides a method as in any of the above embodiments, further comprising a step of mixing the EVL and the amine-containing compound with reinforcing filler, or mixing the polymer with reinforcing filler.

An eighth embodiment provides a method as in any of the above embodiments, wherein the reinforcing filler is selected from carbon black, graphite, silica, nanotubes, clay, and graphene.

A ninth embodiment provides a method as in any of the above embodiments, further comprising a step of subjecting the polymer to conditions for further polymerizing the polymer.

A tenth embodiment provides a method as in any of the above embodiments, further comprising a step of subjecting the polymer to conditions for crosslinking the polymer.

An eleventh embodiment provides a method as in any of the above embodiments, wherein the step of providing the EVL includes providing carbon dioxide and butadiene in a first reaction mixture; and subjecting the first reaction mixture to conditions that will allow the carbon dioxide to be chemically bonded with the butadiene to form the EVL.

A twelfth embodiment provides a method of producing a polymer, the method comprising steps of providing carbon dioxide and an olefin in a first reaction mixture; and subjecting the first reaction mixture to conditions that will allow the carbon dioxide to be chemically bonded with the olefin to form a monomer; providing an amine-containing compound; allowing the monomer and the amine-containing compound to be mixed to form a second mixture; and subjecting the second mixture to conditions that will allow the monomer to chemically combine with the amine-containing compound to produce the polymer.

A thirteenth embodiment provides a method as in any of the above embodiments, wherein the olefin is an acyclic olefin selected from 1,3-butadiene, ethylene, and isoprene.

A fourteenth embodiment provides a method as in any of the above embodiments, wherein the olefin is a cyclic olefin selected from cyclohexadiene, norbornadiene, and α-phellandrene.

A fifteenth embodiment provides a method as in any of the above embodiments, wherein the olefin is butadiene such that the monomer is δ-valerolactone 2-ethylidene-6-hepten-5-olide (EVL).

A sixteenth embodiment provides a method as in any of the above embodiments, wherein the amine-containing compound is a polyfunctional amine compound.

A seventeenth embodiment provides a method as in any of the above embodiments, wherein the polyfunctional amine compound is selected from a diamine compound, a triamine compound, and a tetraamine compound.

An eighteenth embodiment provides a method as in any of the above embodiments, further comprising a step of subjecting the polymer to conditions for further polymerizing the polymer.

A nineteenth embodiment provides a method as in any of the above embodiments, further comprising a step of subjecting the polymer to conditions for crosslinking the polymer.

A twentieth embodiment provides a method as in any of the above embodiments, further comprising a step of mixing the monomer and the amine-containing compound with fibers, or mixing the polymer with fibers.

A twenty-first embodiment provides a method as in any of the above embodiments, wherein the fibers are selected from glass fibers, carbon fibers, silica fibers, natural fibers, and synthetic fibers.

A twenty-second embodiment provides a method as in any of the above embodiments, further comprising a step of mixing the EVL and the amine-containing compound with reinforcing filler, or mixing the polymer with reinforcing filler.

A twenty-third embodiment provides a method as in any of the above embodiments, wherein the reinforcing filler is selected from carbon black, graphite, silica, nanotubes, clay, and graphene.

A twenty-fourth embodiment provides a method as in any of the above embodiments, further comprising a step of chemical recycling the polymer.

A twenty-fifth embodiment provides a method as in any of the above embodiments, further comprising a step of allowing the polymer to degrade.

A twenty-sixth embodiment provides a method as in any of the above embodiments, wherein the EVL is monomeric EVL.

A twenty-seventh embodiment provides a method as in any of the above embodiments, wherein the EVL is part of polymeric EVL.

A twenty-eighth embodiment provides a method as in any of the above embodiments, wherein carbon of the olefin has a pMC value of about 0.

A twenty-ninth embodiment provides a method as in any of the above embodiments, wherein carbon of the olefin has a pMC value of about 100.

A thirtieth embodiment provides a method as in any of the above embodiments, wherein carbon of the olefin has a pMC value of from about 50 to about 100.

A thirty-first embodiment provides a method as in any of the above embodiments, wherein carbon of the carbon dioxide has a pMC value of about 0.

A thirty-second embodiment provides a method as in any of the above embodiments, wherein carbon of the carbon dioxide has a pMC value of about 100.

A thirty-third embodiment provides a method as in any of the above embodiments, wherein carbon of the carbon dioxide has a pMC value of from about 50 to about 100.

A thirty-fourth embodiment provides the polymer made by the method as in any of the above embodiments.

A thirty-fifth embodiment provides a composition including the polymer made by the method as in any of the above embodiments.

A thirty-sixth embodiment provides a composition including a combination product of a lactone; and an amine-containing compound.

A thirty-seventh embodiment provides a composition as in any of the above embodiments, wherein the lactone is δ-valerolactone 2-ethylidene-6-hepten-5-olide (EVL).

A thirty-eighth embodiment provides a method including steps of providing carbon dioxide and an olefin in a first reaction mixture; and subjecting the first reaction mixture to conditions that will allow the carbon dioxide to be chemically bonded with the olefin to form a monomer.

A thirty-ninth embodiment provides a method as in any of the above embodiments, wherein carbon of the olefin has a pMC value of about 0.

A fortieth embodiment provides a method as in any of the above embodiments, wherein carbon of the olefin has a pMC value of about 100.

A forty-first embodiment provides a method as in any of the above embodiments, wherein carbon of the olefin has a pMC value of from about 50 to about 100.

A forty-second embodiment provides a method as in any of the above embodiments, wherein carbon of the carbon dioxide has a pMC value of about 0.

A forty-third embodiment provides a method as in any of the above embodiments, wherein carbon of the carbon dioxide has a pMC value of about 100.

A forty-fourth embodiment provides a method as in any of the above embodiments, wherein carbon of the carbon dioxide has a pMC value of from about 50 to about 100.

A forty-fifth embodiment provides a method as in any of the above embodiments, wherein the olefin is an acyclic olefin selected from 1,3-butadiene, ethylene, and isoprene.

A forty-sixth embodiment provides a method as in any of the above embodiments, wherein the olefin is a cyclic olefin selected from cyclohexadiene, norbornadiene, and α-phellandrene.

A forty-seventh embodiment provides a method as in any of the above embodiments, wherein the olefin is butadiene such that the monomer is δ-valerolactone 2-ethylidene-6-hepten-5-olide (EVL).

### DETAILED DESCRIPTION OF ILLUSTRATIVE EMBODIMENTS

Advantages of the present invention will become better understood with regard to the following description, appended claims, and accompanying drawings wherein:

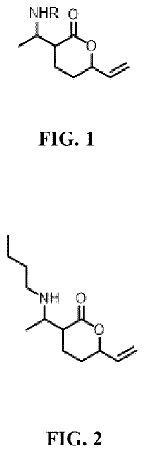

FIG. 1 is a schematic of an intermediate reaction product from 8-valerolactone 2-ethylidene-6-hepten-5-olide (EVL) and an amine, according to one or more embodiments of the invention;

FIG. 2 is a schematic of an intermediate reaction product from EVL and n-butylamine, according to one or more embodiments of the invention;

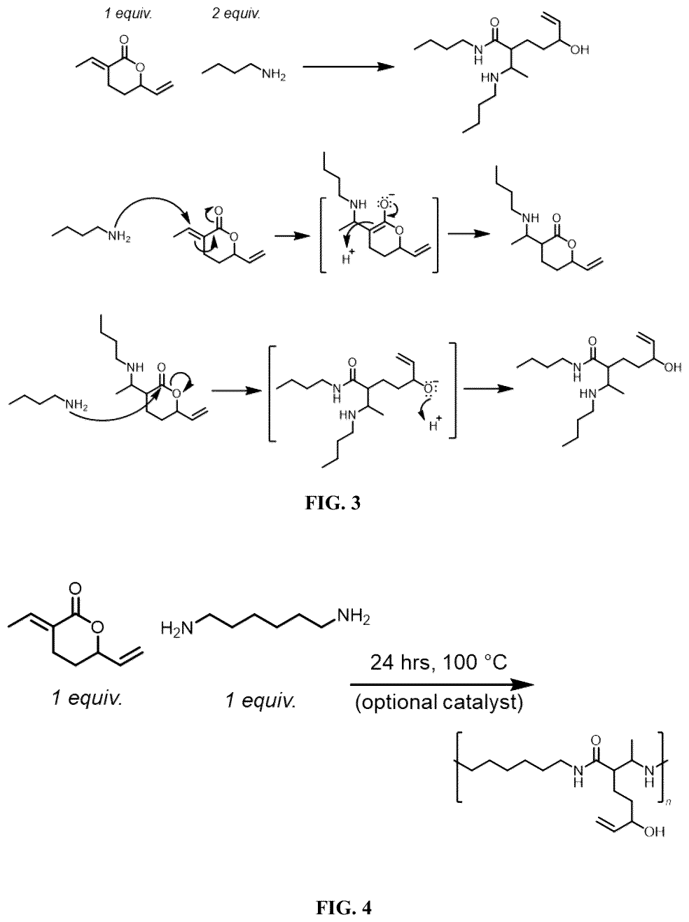

FIG. 3 is a schematic of an overall reaction between EVL and n-butylamine, according to one or more embodiments of the invention;

FIG. 4 is a schematic of an overall reaction between EVL and a difunctional amine (i.e., 1,6-hexanediamine), according to one or more embodiments of the invention;

FIG. 5 is a schematic of an overall reaction between EVL and a trifunctional amine (i.e., tris(2-aminoethyl)amine), according to one or more embodiments of the invention;

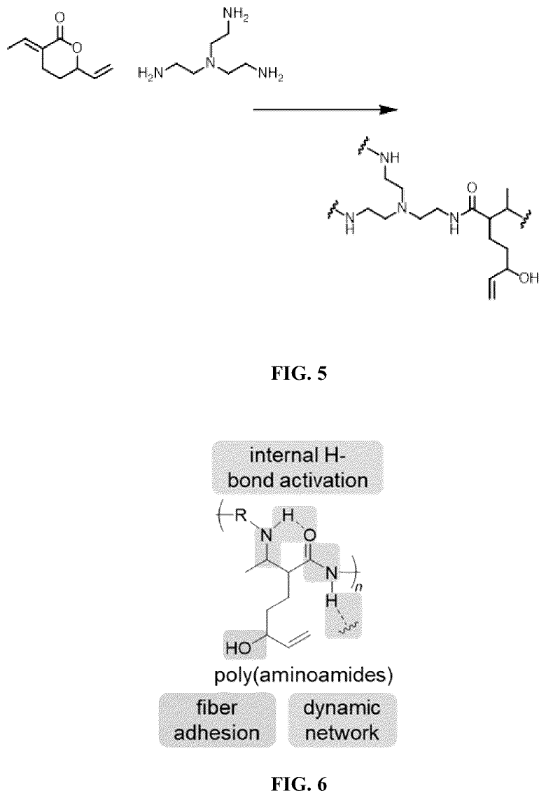

FIG. 6 is a schematic of a poly(aminoamide), according to one or more embodiments of the invention;

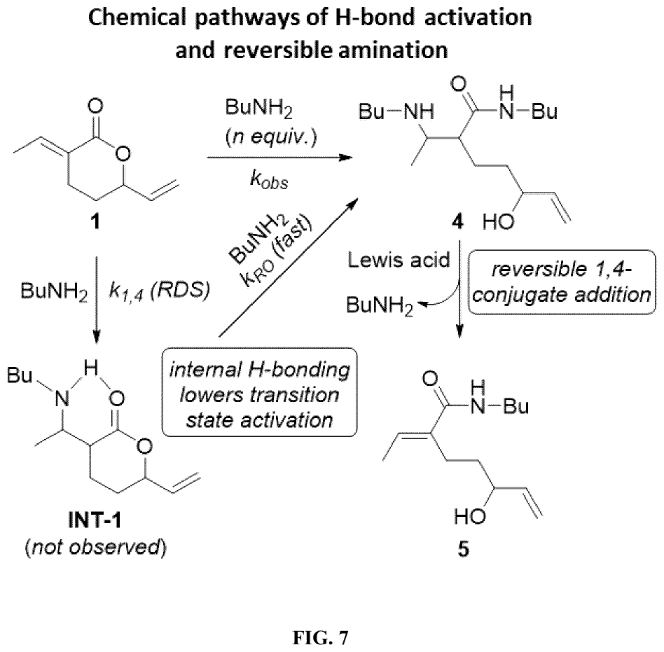

FIG. 7 is a schematic of chemical pathways for the reaction between EVL and n-butylamine (“BuNH₂”), according to one or more embodiments of the invention;

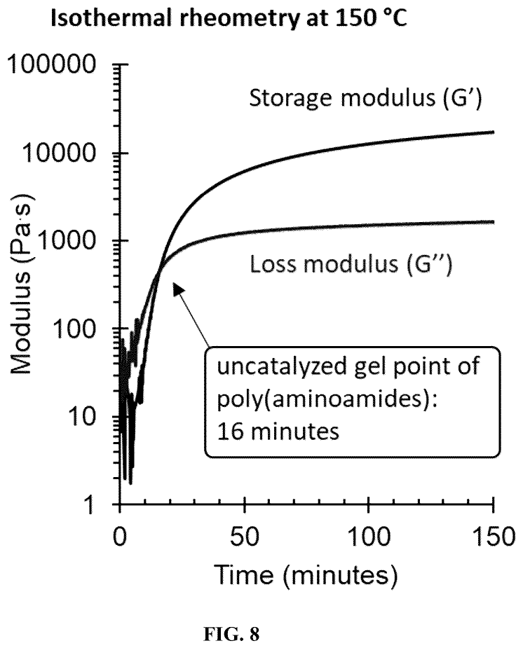

FIG. 8 is a graph showing isothermal rheometry results from one example according to one or more embodiments of the invention;

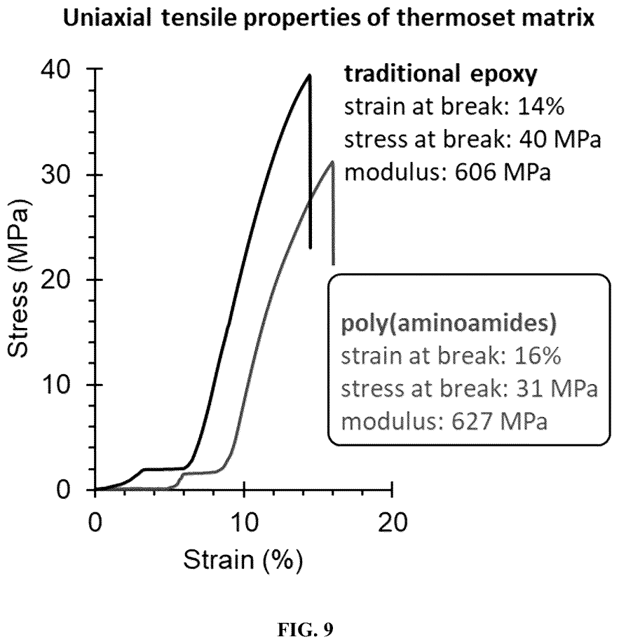

FIG. 9 is a graph showing uniaxial tensile results from one example according to one or more embodiments of the invention compared with a conventional epoxy material;

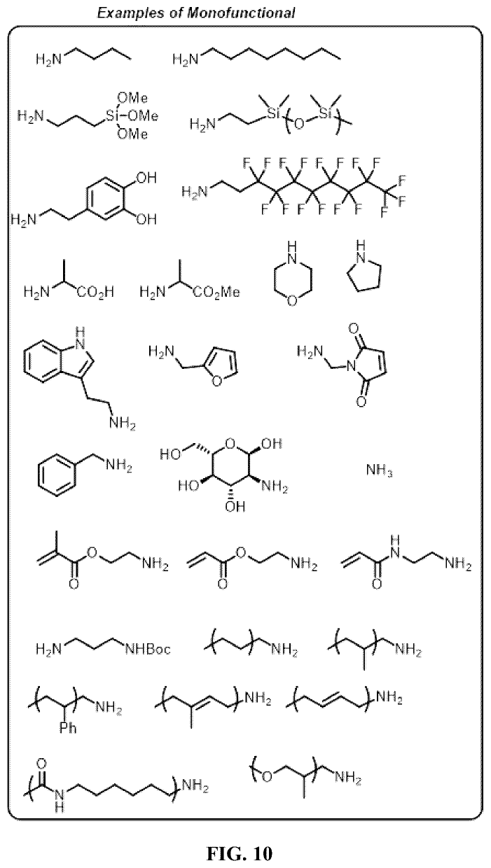

FIG. 10 shows examples of monofunctional amines;

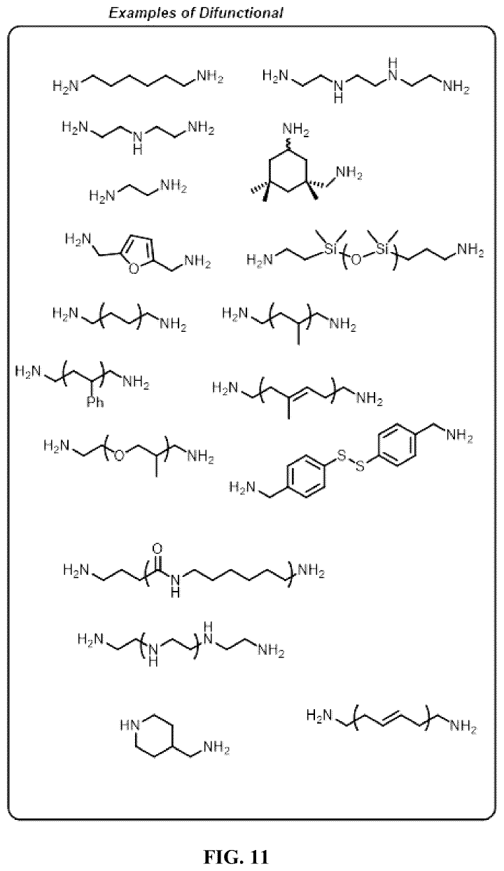

FIG. 11 shows examples of difunctional amines;

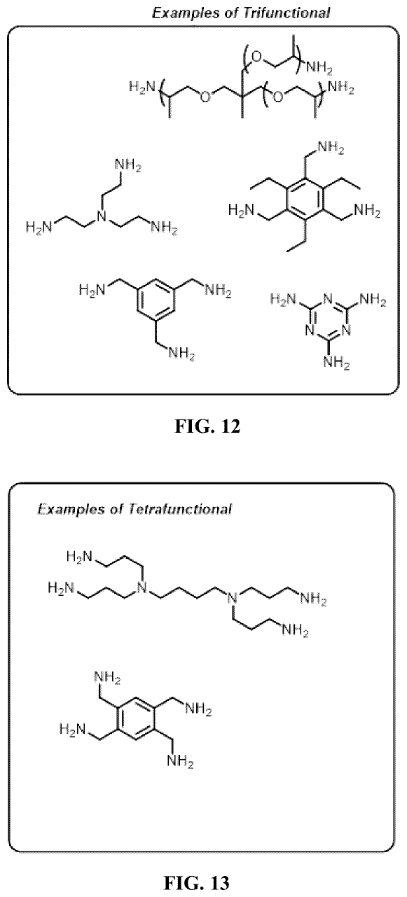

FIG. 12 shows examples of trifunctional amines; and

FIG. 13 shows examples of tetrafunctional amines.

### DETAILED DESCRIPTION OF ILLUSTRATIVE EMBODIMENTS

One or more embodiments of the present invention relate to polymers made from carbon dioxide, an olefin, and an amine, which polymers may also be referred to as co-polymers, polyamides, or poly(aminoamides). One or more embodiments of the present invention relate to combining δ-valerolactone 2-ethylidene-6-hepten-5-olide (EVL) with an amine. This combination generally results in the poly(aminoamide) as an end product. One or more embodiments of the present invention relate to thermosets, thermoplastics, and other materials made from EVL and the amine. Advantageously, one or more embodiments of the present invention offer versatile and tunable materials which can be made in a relatively sustainable and inexpensive manner. Moreover, one or more embodiments of the present invention include chemically recycling a material back to monomers. These or other embodiments of the present invention also include allowing a material to biodegrade.

One or more embodiments of the present invention include a method with a first step of providing EVL. Where utilized, providing EVL may include simply obtaining the EVL. In other embodiments, a method can include making the EVL. Where the EVL is made as part of a method, this generally includes the catalytic conversion of carbon dioxide (CO₂) with an olefin (e.g. 1,3-butadiene (BD)).

Any suitable olefin may be utilized for reaction with the CO₂. The olefin may be acyclic or cyclic. Exemplary acyclic olefins, which may also be referred to as linear olefins, include 1,3-butadiene, ethylene, and isoprene. Exemplary cyclic olefins include cyclohexadiene, norbornadiene, and α-phellandrene. The olefin may be obtained from a renewable source or a petroleum source.

The carbon dioxide is chemically bonded, which may also be referred to as chemically incorporated, with the olefin. The carbon dioxide is therefore chemically bonded within the EVL. This enables the sequestering of the carbon dioxide, a known greenhouse gas, within the EVL. Moreover, the end product after the transformation of the EVL allows for a valuable product that includes the carbon dioxide. The carbon dioxide may be obtained from a renewable source or a petroleum source.

The reaction between the olefin and carbon dioxide may be catalyzed, such as with palladium (e.g. Pd₂(dba)₃). An additional ligand, such as a phosphine (e.g. tris(p-methoxyphenyl)phosphine), and/or a reducing agent (e.g. p-hydroquinone) may also be utilized. A solvent for the reaction may be acetonitrile (MeCN) or a carbonate-based solvent, such as propylene carbonate, ethylene carbonate, or acyclic carbonates. An exemplary temperature for the reaction may be about 70° C. Other details as to the reaction between the olefin and carbon dioxide may generally be known to the skilled person.

As suggested above, the olefin and the carbon dioxide may be obtained from one or more of a renewable source, which may also be referred to as a biobased source, and a petroleum source, which may also be referred to as a fossil fuel source. The amounts of the olefin and the carbon dioxide may each be any suitable value between 0% and 100% relative to both a biobased source and a fossil fuel source. Relatively more material from a biobased source may be utilized where renewable feedstocks are desired. Relatively more material from a fossil fuel source may be utilized where sequestering fossil fuel emissions (i.e., reducing overall carbon emissions) is desired. Relatively more material from a fossil fuel source may be utilized for cost purposes.

The olefin and the carbon dioxide may be characterized by percent of modern carbon (pMC) contained therein. This generally includes determining an isotopic ratio of C¹⁴:C¹² radiocarbon content, for comparing this ratio with fossil fuel and biobased sourcing. Further details are disclosed in ASTM D6866-16, which is incorporated herein by reference for this aspect. As generally known to the skilled person, calculating pMC generally includes determining a ratio of the amount of radiocarbon C¹⁴ in a sample to the amount of a modern reference standard with a known radiocarbon C¹⁴ content generally referenced to the year AD 1950. Zero pMC represents a lack of measurable C¹⁴ atoms above the background signals, thus indicating an exclusively fossil fuel carbon source. 100 pMC indicates an entirely biobased carbon source. A pMC value between 0 and 100 indicates both a fossil fuel carbon source and a biobased carbon source, where the pMC value generally correlates to the amount of biobased carbon present.

As generally known to the skilled person, the pMC can be greater than 100 pMC where the pMC value is adjusted by an atmospheric correction factor (REF). The correction factor REF is generally based on the excess C¹⁴ activity in the atmosphere at the time of testing.

Other aspects relative to determining pMC, biobased sources, and petroleum sources may be disclosed in U.S. Pat. No. 11,180,609, which is incorporated herein by reference for this purpose. U.S. Pat. '609 generally discloses copolymerization of an epoxide with carbon dioxide, and those aspects relative to the epoxide are not incorporated herein.

In one or more embodiments, the carbon of the olefin has a pMC value of about 0. In one or more embodiments, the carbon of the olefin has a pMC value of about 100. In one or more embodiments, the carbon of the olefin has a pMC value of from about 0 to about 50, in other embodiments, from about 0 to about 10, in other embodiments, from about 0 to about 5, in other embodiments, from about 0 to about 1. In one or more embodiments, the carbon of the olefin has a pMC value of from about 50 to about 100, in other embodiments, from about 90 to about 100, in other embodiments, from about 95 to about 100, in other embodiments, from about 99 to about 100. In one or more embodiments, the carbon of the olefin has a pMC value of less than 50, in other embodiments, less than 25, in other embodiments, less than 10, in other embodiments, less than 5. In one or more embodiments, the carbon of the olefin has a pMC value of greater than 50, in other embodiments, greater than 75, in other embodiments, greater than 90, in other embodiments, greater than 95.

In one or more embodiments, the carbon of the carbon dioxide has a pMC value of about 0. In one or more embodiments, the carbon of the carbon dioxide has a pMC value of about 100. In one or more embodiments, the carbon of the carbon dioxide has a pMC value of from about 0 to about 50, in other embodiments, from about 0 to about 10, in other embodiments, from about 0 to about 5, in other embodiments, from about 0 to about 1. In one or more embodiments, the carbon of the carbon dioxide has a pMC value of from about 50 to about 100, in other embodiments, from about 90 to about 100, in other embodiments, from about 95 to about 100, in other embodiments, from about 99 to about 100. In one or more embodiments, the carbon of the carbon dioxide has a pMC value of less than 50, in other embodiments, less than 25, in other embodiments, less than 10, in other embodiments, less than 5. In one or more embodiments, the carbon of the carbon dioxide has a pMC value of greater than 50, in other embodiments, greater than 75, in other embodiments, greater than 90, in other embodiments, greater than 95.

In one or more embodiments, after the EVL is obtained, the EVL is combined with an amine. The EVL can be in monomer form or in the form of polymeric EVL. The term amine can refer to an overall compound containing one or more amine groups, or can refer to the one or more amine groups, which groups may also be referred to as amino groups. The amine, which may also be referred to as an amine-containing compound, an amine compound, can be a monoamine or a polyfunctional amine. Exemplary polyfunctional amines include a difunctional amine, a trifunctional amine, and a tetrafunctional amine. Polyfunctional amines may be desirable relative to producing polymeric end products, though the products made from monoamines may have other desirable applications. An exemplary amine-containing compound is a polymer functionalized with amino groups.

In one or more embodiments, the conditions under which the amine and EVL are combined, which may also be referred to as reaction conditions or combination conditions, include avoiding polymerizing the EVL prior to the combination with the amine. That is, the reaction conditions can be such that the EVL primarily reacts with the amine. In one or more embodiments, the reaction conditions include first homopolymerizing the EVL, and then subsequently crosslinking the polymeric EVL with the amine. In one or more embodiments, the reaction conditions include homopolymerizing the EVL and simultaneously homo-crosslinking the EVL prior to the combination with the amine.

The δ-valerolactone 2-ethylidene-6-hepten-5-olide (EVL) is a lactone. Lactones can be generally described as cyclic carboxylic esters, containing a 1-oxacycloalkan-2-one structure (—C(═O)—O—). Lactones may also include analogues having unsaturation or heteroatoms replacing one or more carbon atoms of the ring. EVL may be described as a disubstituted lactone, an unsaturated lactone, or a disubstituted unsaturated lactone.

Other suitable reactants in addition to EVL may also be utilized in the reactions and methods disclosed herein. These additional suitable reactants may include those that share similar properties, such as being cyclic and including the unsaturation. The additional suitable reactants may be cyclic dienes. The additional suitable reactants may include other lactones or cyclic carbonates. Specific additional reactants include lactide, caprolactone, butyrolactones, and 6-member cyclic carbonates (e.g. trimethylenecarbonate).

In one or more embodiments, the EVL does not need to be of relatively high purity, though the EVL may be of relatively higher purity. In one or more embodiments, the EVL or other suitable reactant has a purity of from about 50% to about 100%, in other embodiments, from about 50% to about 90%, in other embodiments, from about 60% to about 80%, in other embodiments, from about 60% to about 90%, and in other embodiments, from about 65% to about 75%, relative to an overall composition containing the EVL prior to combination with the amine. In one or more embodiments, the EVL or other suitable reactant has a purity of at least 90%, in other embodiments, at least 95%, in other embodiments, at least 98%, in other embodiments, at least 99%, and in other embodiments, about 100%, relative to an overall composition containing the EVL prior to combination with the amine. Purity can be determined by any suitable technique, such as 1H NMR spectroscopy, LC-MS, and GC-MS, as generally known to the skilled person.

In one or more embodiments, the amine does not need to be of relatively high purity, though the amine may be of relatively higher purity. In one or more embodiments, the amine has a purity of from about 50% to about 100%, in other embodiments, from about 50% to about 90%, in other embodiments, from about 60% to about 80%, in other embodiments, from about 60% to about 90%, and in other embodiments, from about 65% to about 75%, relative to an overall composition containing the amine prior to combination with the EVL. In one or more embodiments, the amine has a purity of at least 90%, in other embodiments, at least 95%, in other embodiments, at least 98%, in other embodiments, at least 99%, and in other embodiments, about 100%, relative to an overall composition containing the amine prior to combination with the EVL.

As suggested above, after the EVL is obtained, the EVL can be combined with an amine, which combination may be referred to as, or may include, reaction, polymerization, copolymerization, and crosslinking. Desired end products include thermoplastic polyamides and thermosetting polyamides, which may also be referred to as polymers or poly(aminoamides). Overall, the thermoplastic polyamides and thermosetting polyamides are made from the conversion of olefins (e.g., butadiene), carbon dioxide, and amines. The conditions for the combination, and the specific components being combined, can be modified based on a desired end product. Exemplary conditions include temperature, solvent, phase of the components, and ratio of the components. A variety of these conditions will be suitable, and the specific conditions utilized can be tailored based on the desired end product.

The conditions for combining the EVL and amine may include any suitable temperature and cure time. Generally speaking, the temperature for the combination of the EVL and amine may also be adjusted based on a desired cure time and drying time for an end product. That is, relatively higher temperatures will generally achieve faster curing and drying, which faster times can be desired for an end product. Relatively faster cure times may be desirable for faster manufacturing and for molded objects or composites. Relatively longer cure times may be suitable for manufacturing larger fiber composites (e.g., wind turbines).

In one or more embodiments, the combination conditions may include combination at room temperature (e.g., about 20° C. to 22° C.), which may be desirable for certain end products. In one or more embodiment, room temperature conditions allow for a product where an end customer can perform the step of combining the EVL and amine.

In one or more embodiments, which may include a combination temperature of room temperature, a cure time can be from about 1 hour to about 24 hours, in other embodiments, from about 1 hour to about 12 hours, in other embodiments, from about 12 hours to about 36 hours, and in other embodiments, from about 6 hours to about 12 hours.

As suggested above, one or more embodiments include utilizing conditions at relatively higher temperatures. In one or more embodiments, the combination of the EVL and amine may be at a temperature of from about 50° C. to about 200° C., in other embodiments, from about 75° C. to about 175° C., in other embodiments, from about 100° C. to about 150° C., and in other embodiments, from about 100° C. to about 200° C.

In one or more embodiments, which may include a combination temperature of relatively higher temperatures, a cure time can be from about 10 minutes to about 3 hours, in other embodiments, from about 10 minutes to about 30 minutes, in other embodiments, from about 20 minutes to about 40 minutes, in other embodiments, from about 1 hour to about 3 hours, in other embodiments, from about 1 hour to about 2 hours, and in other embodiments, from about 30 minutes to about 1 hour.

In one or more embodiments, a cure time can less than 3 hours, in other embodiments, less than 2 hours, in other embodiments, less than 1 hour, in other embodiments, less than 45 minutes, in other embodiments, less than 30 minutes, and in other embodiments, less than 15 minutes.

As suggested above, after the EVL is obtained, other embodiments include first homopolymerizing the EVL, which may or may not include simultaneously crosslinking the EVL, prior to the combination with the amine. Such embodiments can generate useful amino and amide functionality or crosslinks. These embodiments can utilize any of the temperatures and cure times disclosed herein.

Aspects of the optional polymerization of the EVL are now described. The δ-valerolactone 2-ethylidene-6-hepten-5-olide (EVL) can undergo a catalyzed reaction of vinylogous 1,4-conjugate addition to form a dimer (di-EVL), and polymerization to form polymeric macromolecules (poly-EVL). The dimer is believed to be a mixture of eight diastereomers. A variety of specific macromolecules may be formed. The catalyst may be an organocatalyst, which may be 1,5,7-triazabicyclo[4.4.0]dec-5-ene (TBD). Other suitable catalysts may include DBU (1,8-Diazabicyclo(5.4.0) undec-7-ene), thioureas, alkylated TBD, guanidine, alkylated guanidines, and phosphazenes. Other bifunctional catalysts may be suitable for use as the catalyst. The TBD or other catalyst may be provided within a solvent. An exemplary solvent is diethyl ether (Et₂O). Other aprotic solvents may also be utilized. The polymerization of the EVL may be aided by an initiator. A suitable initiator may be an alcohol for alcohol-initiated ring-opening polymerization. An exemplary alcohol initiator is benzyl alcohol (BnOH). Other suitable initiators may be generally known to the skilled person. Though a polymeric material can be produced without an initiator. The EVL may undergo a modification step before polymerization. An exemplary modification step is hydrogenation. The modification step (e.g. hydrogenation) may be selected in order to produce desirable end materials with tunable thermal properties. Where a hydrogenation step is utilized, this includes partial elimination or complete elimination of the unsaturation within the monomer by introducing hydrogen. This introduction of hydrogen is after the monomer has been produced, for example at the end of the EVL monomer synthesis.

In one or more embodiments, the polymerization of the EVL may proceed under bulk polymerization conditions. That is, the reaction of the EVL or other suitable monomer may be generally solvent-free. As generally known to the skilled person, bulk polymerization conditions include reacting the monomer in liquid state, optionally in the presence of an initiator, where the reaction is initiated by sufficient or exposure to radiation. In one or more embodiments, the polymerization of the EVL may be devoid of solvent, in other embodiments, less than 1 wt. % solvent, in other embodiments, less than 0.5 wt. % solvent, and in other embodiments, less than 0.1 wt. % solvent, relative to an overall polymerization mixture.

Other aspects relative to the polymerization of the EVL are disclosed in U.S. Publication No. 2022/0073675, which is incorporated herein by reference for this purpose.

Details of the reaction mechanism between the EVL and the amine are now described. The reaction of the EVL and the amine includes 1,4-conjugate addition and lactone ring-opening amidation reactions. EVL is a biselectrophile (A₂) capable of reacting with di-(B₂), tri-(B₃), and multi-functional (Bₙ)amines, which may also be referred to as a polyfunctional nucleophile.

Where two moles, which may also be referred to as equivalents, of a monofunctional amine (e.g., n-butylamine) are combined with one mole of EVL, FIG. 3 shows an entire reaction schematic. Exemplary initial intermediate reaction products made from the EVL and the amine are shown in FIG. 1 and FIG. 2. In FIG. 1, R can be any suitable compound or group, such as a hydrocarbyl group, which can be substituted or unsubstituted. FIG. 2 shows an intermediate reaction product from EVL and one mole of n-butylamine.

As perhaps best seen in FIG. 6, the product materials generally possess three network linkages: non-covalent H-bonds, amine linkages from 1,4-conjugate addition, and amide linkages from lactone ring-opening. Each of these linkages are dynamic and reversible under orthogonal conditions, which imparts tunable self-healing properties. The reaction between the EVL and the amine will generally produce dynamic network structures, which enable self-healing properties and reprocessability. These reversible network structures further enable tunable rheological processing properties for composite pre-pregs, material self-healing, and end-of-use fiber recovery.

The amine, which, again, can refer to an overall compound containing one or more amine groups, or can refer to the one or more amine groups, can be varied based on a desired end product. The amine can be a monosubstituted amine. The amine can be a monofunctional amine or a polyfunctional amine, which may also be referred to as a multi-functional amine. The amine can be terminal or pendant. The amine can be ammonia or ammonia hydroxide. The amine can include a mixture of these various characteristics, including being provided in a composition containing both, for example, diamines and triamines.

FIG. 3 shows a monofunctional amine for reaction with the lactone monomer (e.g., EVL). This end product may be useful as a plasticizer for nylon, poly(vinylchloride), polyesters, and other commercial products. Inclusion of a monofunctional amine is further an effective way of controlling the molecular weight and crosslinking density of resulting polymers from reacting with amines.

Exemplary monofunctional amines include methylamine, butylamine, hexylamine, octylamine, benzyl amine, glycosamines, 1-(2-Aminoethyl) pyrrolidine, N-Boc-N-methylethylenediamine, 4-(2-Aminoethyl) morpholine, or amino acids. Polymeryl amines such as polyethylene amine, polypropylene amine, polybutadiene amine, polyisoprene amine may be further useful in creating end-functionalized polymers for a range of rubber and plastic applications. Functionalized amines such a furfuryl amine, acylated amines such as 2-aminoethyl acrylate, and maleimides such as 1-(2-aminoethyl)-1H-pyrrole-2,5-dione are useful for creating dynamic networks and secondary interactions within the materials. Other monofunctional amines include dopamine, aminosiloxanes such as (3-aminopropyl) trimethoxysilane, and perfluorinated alkyl amines such as 1H, 1H-perfluorooctylamine.

FIG. 10 shows compounds for certain examples of monofunctional amines.

FIG. 4 shows a polyfunctional amine as a difunctional amine for reaction with the lactone monomer (e.g., EVL). This end product may be a melt-processable thermoplastic polyamide with variable glass transition and melting temperatures, which can depend on the diamine comonomer. These end products and corresponding compositions may be useful as fibers, plastics, and elastomers.

Exemplary difunctional amines include 1,2-ethylenediamine, 1,4-butaneiamine, 1,6-hexanediamine, 1,8-octanediamine, isophorone diamine, diethylenetriamine, furfuryl diamine, N′-bis(3-aminopropyl)-1,3-propanediamine, 3,3′-diamino-N-methyldipropylamine, 1,2-bis(3-aminopropylamino) ethane, 1,4-bis(3-aminopropyl) piperazine, and di-end functionalized polymeryl amines (also known as telechelic polymers) such as telechelic polyethylene diamine, nylons, polydimethylsiloxane diamine, polypropylene diamine, polybutadiene diamine, and polyisoprene diamine. Disulfide containing diamines such as (disulfanediylbis(4,1-phenylene))dimethanamine are further useful in creating dynamic networks triggered thermally or through oxidation/reduction reactions.

FIG. 11 shows compounds for certain examples of difunctional amines.

FIG. 5 shows a polyfunctional amine as a trifunctional amine for reaction with the lactone monomer (e.g., EVL). These end products and corresponding compositions may be useful as a high-strength composite having a relatively high tensile strength (e.g., greater than 30 Mpa). These end products and corresponding compositions may have tensile strengths as good or better than polypropylene, for example. Where the polyfunctional amine is a triamine or higher, reaction with the EVL will generally produce a crosslinkable product, as shown in FIG. 5.

Exemplary trifunctional amines include tris(2-aminoethyl)amine. Additional examples include tris(3-aminopropyl)amine, 1-(2-aminoethyl) piperazine, 4-(aminomethyl) piperidine, and 2-(aminomethyl)-2-methyl-1,3-propanediamine.

FIG. 12 shows compounds for certain examples of trifunctional amines.

As disclosed herein, a polyfunctional amine can also be a tetrafunctional amine for reaction with the lactone monomer (e.g., EVL). Exemplary tetrafunctional amines include polypropylenimine tetramine dendrimer, and 2,4,6-triethyl-1,3,5-benzenetrimethanamine.

FIG. 13 shows compounds for certain examples of tetrafunctional amines.

In one or more embodiments, the functional amine can be polymeric, for reaction with the lactone monomer (e.g., EVL). These end products and corresponding compositions may be useful for producing block copolymers and dynamically crosslinked materials. Polymeric amines include polyethyleneamine, natural rubber, polyaniline, polydopamine, amine-functionalized silicone, nitrile rubber and its aminated derivatives, amine-functionalized polybutadiene, nylons, and polypropylenimine tetramine dendrimer.

As suggested above, a variety of amines can be provided within a composition for combination with the EVL. For example, an amine composition can include a desired ratio of diamines to triamines, which ratio might be adjusted to achieve a desired molecular weight for an end product application.

As mentioned above, the polyfunctional amines may be referred to as polyfunctional nucleophiles. Therefore, in addition to polyfunctional amines, other polyfunctional nucleophiles may be utilized in place of the amine or in combination with the amine. Other suitable polyfunctional nucleophiles for combination with the EVL include thiols, alcohols, carboxylates, thiocarboxylates, dithiocarboxylates, hydroxylamines, and phosphines. Disubstituted amines can be used, and include diethylamine, pyrimidine, proline, and morpholine.

Monosubstituted amines are generally autocatalytic, which may be referred to as including an internal catalyst, and therefore one or more embodiments can include combining the EVL and the amine without a catalyst. That is, one or more embodiments may be devoid of catalyst, and other embodiments may be substantially devoid of catalyst, for combining the EVL and the amine.

In one or more embodiments, the combination of the EVL and the amine may be in the presence of a catalyst, which would be included in a catalytic amount. The catalyst may be a Lewis acid or a Lewis base. Other exemplary catalysts include tin carboxylates (e.g., tin dioctanoate), dialkyl tin carboxylates (e.g., dibutyl tin dioctanoate), dialkyl tin chlorides (e.g., dibutyltin dichloride), and other substitutes for these catalysts as generally known relative to polyurethane and ring-opening polymerization (e.g., bismuth, zinc, antimony). Other exemplary catalysts include organic catalysts such as pyridine, dimethylamino pyridine (DMAP), 1,8-Diazabicyclo(5.4.0) undec-7-ene (DBU), phosphazene bases, and other generally known transesterification, transamidation, and ring-opening polymerization organocatalysts.

In one or more embodiments, the combination of the EVL and amine may be under bulk polymerization conditions. That is, the reaction of the EVL and amine may be generally solvent-free. In one or more embodiments, the combination of the EVL and amine may be devoid of solvent, in other embodiments, less than 1 wt. % solvent, and in other embodiments, less than 0.5 wt. % solvent, relative to an overall composition containing the EVL and amine, or the product thereof.

In one or more embodiments, the combination of the EVL and amine may be in the presence of a solvent. Exemplary solvents include toluene, acetonitrile, mineral spirits, water emulsions, and other organic solvents generally known to the skilled person. As with the above disclosed suitable temperatures, solution phase reactions can be effective at both room temperature and relatively elevated temperatures.

The combination of the EVL and amine may be at a variety of ratios of the two components. The ratios here are given relative to moles of amine groups (NH₂) per one mole EVL. EVL is a biselectrophile, so a 2:1 molar ratio of moles of NH₂:moles of EVL is the theoretical ratio for the reaction. This molar ratio of about 2:1 for moles of NH₂:moles of EVL may be desirable to achieve high molecular weights and high strength. In other embodiments, other ratios are useful. Other ratios may provide products of prepolymers, prepregs, adhesives, and sealants. Other embodiments include ratios of from about 0.5:1 to about 3:1, in other embodiments, from about 0.5:1 to about 2:1, in other embodiments, from about 1:1 to about 3:1, and in other embodiments, from about 1:1 to about 2:1, for moles of NH₂:moles of EVL. At ratios of NH₂:EVL of about 2:1, relatively high molecular weight material can be produced (>10,000 g/mol) which may be useful for fibers, coatings, elastomers, sealants, plastics, and reinforced composites. At ratios of NH₂:EVL of <2:1, low molecular precursor pre-pregs may be formed that can be further cured. This curing can take place thermally or chemically depending on the target properties. In one or more embodiments, excess amine is used relative to EVL (about 2:1 to about 5:1; NH₂:EVL). The resulting product has amine end-groups and relatively low molecular weights (<10,000 g/mol), which product may be useful for producing polyurea and polyurethane coatings, adhesives, sealants, and elastomers.

The combination of the EVL and amine may be within a certain phase. In one or more embodiments, combining the materials can be done as a liquid/liquid mixture. Here, the viscosity can generally be controlled by the choice of a particular functional amine. For embodiments where a reinforced fiber product application is desired, a relatively lower viscosity may be advantageous. For embodiments where a coating product application is desired, viscosity can generally be increased through one or more of partial reaction, blending with a modifier, and utilizing a high viscosity amine.

In other embodiments, the components can be reacted in the gas phase. Utilizing the gas phase may offer advantages for penetration of the material into crevices, fracture sites, and between fibers. This furthermore can allow for advanced manufacturing of parts and shapes difficult for liquid resins to flow into (e.g., <50 microns in diameter). In still other embodiments, the components can be reacted as a liquid/gas mixture.

In one or more embodiments, the product may be characterized by amount of repeat units (e.g., n in FIG. 4, and the length of the crosslink network in FIG. 5). Any suitable number of repeat units may be utilized based on a desired end product. An exemplary range of repeat units is from about 50 to about 500 repeat units. In other embodiments, molecular weights ranging from 500 to 10,000 repeat units may be desirable. When trifunctional, tetrafunctional, or multifunctional amines are used, crosslinked thermosets can be formed with an incalculably large number of repeat units.

In one or more embodiments, the product may be characterized by molecular weight, which may be either number average molar mass (Mₙ) or mass average molar mass (M_{w}). The molecular weight may be determined by any suitable technique, such as gel permeation chromatography (GPC). The number average molecular weight (Mₙ) may be tailored to a desired end product. For example, a molecular weight of about 2,000 g/mol may be useful for an adhesive end product and a molecular weight of about 60,000 g/mol may be useful for a fiber end product. As generally known to the skilled person, any crosslinked end products will generally have an incalculably high molecular weight.

In one or more embodiments, the product may have a number average molar mass (Mₙ) of from about 500 g/mol to about 2,000 g/mol, which may be useful for prepregs. In one or more embodiments, the product may have a number average molar mass (Mₙ) of from about 2,000 g/mol to about 10,000 g/mol, which may be useful for adhesives. In one or more embodiments, the product may have a number average molar mass (Mₙ) of from about 10,000 g/mol to about 100,000 g/mol, which may be useful for fibers and plastics. In one or more embodiments, the product may have a number average molar mass (Mₙ) of from about 100,000 g/mol to about 5,000,000 g/mol, which may also be useful for fibers and plastics.

The product of the combination of the EVL and amine may be useful for combination with a reinforcing component to form a composite. Exemplary reinforcing components include one or more of fibers, filler, and carbon-rich nanomaterials.

As shown in FIG. 6, the product includes pendant alcohol moieties, which can offer improved physical and chemical interactions with fibers. A combination with a reinforcing component (e.g., fibers) may be before or after the EVL and amine are combined. That is, the reactants may be combined with reinforcing component or the products may be combined with reinforcing component. The combination can be only, or substantially only, the reinforcing component and the EVL and amine, or the product thereof. That is, a composite can be made from a composition devoid of, or substantially devoid of, solvent. In one or more embodiments, a composite can be made from a composition with less than 1 wt. % solvent, in other embodiments, less than 0.5 wt. % solvent, and in other embodiments, less than 0.1 wt. % solvent, relative to an overall composition containing the reinforcing component and the EVL and amine, or the product thereof.

The fibers may be any suitable fibers, which may include those which serve as reinforcing fibers, which may also be referred to as reinforcing filler. The fibers may be one or more of natural fibers and synthetic fibers. Exemplary fibers include glass fibers, carbon fibers, and silica fibers.

A composite or other end product may also include a filler. Exemplary fillers, which may also be referred to as reinforcing fillers, include carbon black, graphite, silica, nanotubes, clay (e.g., nanoclays), graphene, boron nitride, wood flour, recycled polymers, and other generally known fillers.

Relative to one or more embodiments of an end product, the formulation, fiber sizing, and processing methods may be adjusted relative to achieved desired composites. The relatively low-viscosity precursors and pendant alcohol moieties should improve the physical and chemical interactions with the fibers. Fiber precursors (e.g., weave, chopped, uniaxial, and diameter) may be adjusted for achieving certain end product applications such as automotive, aerospace, and consumer products.

As suggested above, the product materials may be reprocessed at relatively elevated temperature as a result of the dynamic nature of the networks. This may be referred to as chemical recyclability or chemical recycle to monomers. As generally known to the skilled person, this reprocessing generally includes controlled, mild depolymerization of the end product in order to re-obtain the monomers (e.g., EVL and amine) for reuse. As generally known to the skilled person, this reprocessing can include heating and a catalyst.

As suggested above, the product of one or more embodiments of the present invention is a degradable product. Due to the high carbon dioxide content in these materials and their carbon-negative footprint, it may be desirable to sequester the material in the ground by burying. This may be particularly useful for sealants and containers of toxic and hazardous materials such as biomedical waste, perfluorinated chemicals, radioactive waste, and hazardous chemicals. This degradation may also be referred to as being hydrolytically degradable or depolymerizable. Said another way, the product may be receptive of hydrolysis under certain conditions. The hydrolysis conditions may be without assistance from an enzyme. The hydrolysis conditions may be atmospheric conditions. In one or more embodiments, the hydrolysis conditions may be at a temperature of about 80° C. and include the use of about 1 M NaOH. Additional recycling conditions include catalytic degradation with an inorganic acid catalyst such as zinc acetate, acidic silica, or zirconia clay.

In one or more embodiments, the EVL may be produced as a minor product, and other coproducts of the reaction between the olefin and carbon dioxide may be targeted. The coproducts may be linear or branched vinyl containing compounds. The coproducts can be thermally cured or oxidatively cured. The reaction can be auto initiated, photochemically initiated, or activated by the addition of a radical initiator such as azo initiators or peroxide initiators. The resulting material will generally be a tacky, highly integrated, polymer network which may have usefulness as a tackifier, adhesive, pressure sensitive adhesive, rubber, elastomer, reinforcing agent in an impact modified polymer (e.g., polystyrene, polypropylene), coating, or hardening oil. The coproducts may be used independently or as a mixture. The resulting product may be a gel having a relatively low grass transition temperature, such as below −50° C., which makes the product comparable relative to other elastomers, such as natural rubber and polybutadiene. The coproducts may be reacted at a temperature of from about 125° C. to about 150° C., and in other embodiments, from about 135° C. to about 150° C.

### EXAMPLES

### Example 1

In one example, the lactone EVL was evaporated at 80° C. under vacuum into a vacuum mold held at 150° C. To this, trifunctional amine was introduced under vacuum in the gas phase (114° C. at 15 mmHg). The gases were held and mixed in the mold at 150° C. under vacuum for the cure time of 40 minutes.

### Example 2

In one example, the lactone EVL was combined in a 2:1 molar ratio with bisethylenetriamine at 25° C. and cured for 24 hours at 100° C. The resulting material behaved as an adhesive gum for use as a pressure sensitive adhesive and prepolymer for further curing.

### Example 3

In one example, the lactone EVL was combined in a 1:1 molar ratio with bisethylenetriamine and heated to 100° C. for 24 hours with a catalytic amount of tin dioctanoate (1 wt. %). The resulting material formed a high modulus strong thermosetting material with high T_{g} and high mechanical strength within 1 hour. Similar observations were made when ethylene diamine, 1,6-hexanediamine, tris(aminoethyl)amine, and melamine were used in the same equivalents and conditions.

### Example 4

In one example, the lactone EVL was combined in a 2:1 molar ratio with 1,6-hexanediamine with a catalytic amount of 1,8-Diazabicyclo(5.4.0) undec-7-ene (DBU) (1 wt. %) at 25° C. and cured at room temperature. The resulting material behaved as a soft elastomer with a low T_{g} and coherent elasticity.

### Example 5

In one example, the lactone EVL was combined in a 1:1 molar ratio with tris(aminoethyl)amine. The low viscosity liquid was then added to a matrix of oriented carbon fibers and cured at 100° C. with 0.1 wt. % dibutyl tin dioctanoate for 1 hour. The resulting carbon fiber reinforced composite was found to be suitable for lightweight composite applications.

### Example 6

In one example, polymeric EVL was prepared by contacting EVL with 1,5,7-triazabicyclo[4.4.0]dec-5-ene (TBD) in a 20:1 molar ratio and reacted for 2 days. The product was precipitated in diethyl ether and a polymeric EVL product was isolated. The polymeric EVL product was reacted with ethylene diamine in a 1:1 molar ratio of alkene:amine for 24 hours at room temperature. This resulted in a crosslinked gelatin. The glass transition temperature was increased in the product by 15 degrees Celsius. 15

### Example 7

In one example, isothermal rheometry results were obtained, which results are shown in the graph of FIG. 8.

### Example 8

In one example, uniaxial tensile results were obtained and compared with a conventional epoxy material, which is shown in the graph of FIG. 9.

### Example 9

In one example, the lactone EVL was combined in a 1:2/3 molar ratio with tris-(2-aminoethyl)amine (TREN). A Petri dish was lined with a Teflon™ sheet. An oven was heated to 150° C. TREN was massed in a 20 mL vial (5.22 mmol, 0.764 g) as a viscous yellow liquid. EVL was massed in a 20 mL vial (7.80 mmol, 1.187 g) as a clear liquid. Upon the next step, the viscosity increased quickly and made the material difficult to handle. The EVL was added EVL to the TREN and stirred manually with a pipette, which resulted in a viscous yellow gel. This mixture was transferred to the Petri dish. The Petri dish was placed in the oven and the mixture was cured for 1.5 hrs. The Petri dish was retrieved from the oven and allowed to cool. The product of FIG. 5 was obtained.

In light of the foregoing, it should be appreciated that the present invention significantly advances the art by providing improved polyamides made from carbon dioxide, an olefin, and an amine. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. A method of producing a polymer, the method comprising steps of
providing δ-valerolactone 2-ethylidene-6-hepten-5-olide (EVL);
providing an amine-containing compound;
allowing the EVL and the amine-containing compound to be mixed to form a mixture; and
subjecting the mixture to conditions that will allow the EVL to chemically combine with the amine-containing compound to produce the polymer.

2. The method of claim 1, wherein the amine-containing compound is a polyfunctional amine compound.

3. The method of claim 2, wherein the polyfunctional amine compound is selected from a diamine compound, a triamine compound, and a tetraamine compound.

4. (canceled)

5. The method of claim 1, further comprising a step of mixing the EVL and the amine-containing compound with fibers, or mixing the polymer with fibers.

6. The method of claim 5, wherein the fibers are selected from glass fibers, carbon fibers, silica fibers, natural fibers, and synthetic fibers.

7. The method of claim 1, further comprising a step of mixing the EVL and the amine-containing compound with reinforcing filler, or mixing the polymer with reinforcing filler.

8. The method of claim 7, wherein the reinforcing filler is selected from carbon black, graphite, silica, nanotubes, clay, and graphene.

9. (canceled)

10. (canceled)

11. (canceled)

12. A method of producing a polymer, the method comprising steps of
providing carbon dioxide and an olefin in a first reaction mixture; and
subjecting the first reaction mixture to conditions that will allow the carbon dioxide to be chemically bonded with the olefin to form a monomer;
providing an amine-containing compound;
allowing the monomer and the amine-containing compound to be mixed to form a second mixture; and
subjecting the second mixture to conditions that will allow the monomer to chemically combine with the amine-containing compound to produce the polymer.

13. The method of claim 12, wherein the olefin is an acyclic olefin selected from 1,3-butadiene, ethylene, and isoprene.

14. The method of claim 12, wherein the olefin is a cyclic olefin selected from cyclohexadiene, norbornadiene, and α-phellandrene.

15. The method of claim 12, wherein the olefin is butadiene such that the monomer is δ-valerolactone 2-ethylidene-6-hepten-5-olide (EVL).

16. The method of claim 12, wherein the amine-containing compound is a polyfunctional amine compound.

17. The method of claim 16, wherein the polyfunctional amine compound is selected from a diamine compound, a triamine compound, and a tetraamine compound.

18. (canceled)

19. (canceled)

20. The method of claim 12, further comprising a step of mixing the monomer and the amine-containing compound with fibers, or mixing the polymer with fibers.

21. The method of claim 20, wherein the fibers are selected from glass fibers, carbon fibers, silica fibers, natural fibers, and synthetic fibers.

22. The method of claim 12, further comprising a step of mixing the EVL and the amine-containing compound with reinforcing filler, or mixing the polymer with reinforcing filler.

23. The method of claim 22, wherein the reinforcing filler is selected from carbon black, graphite, silica, nanotubes, clay, and graphene.

24. The method of claim 1, further comprising one or more steps of chemical recycling the polymer and allowing the polymer to degrade.

25.-35. (canceled)

36. A composition comprising
a combination product of
a lactone; and
an amine-containing compound.

37. The composition of claim 36, wherein the lactone is δ-valerolactone 2-ethylidene-6-hepten-5-olide (EVL).

38.-47. (canceled)
